(19) United States
(12) Patent Application Publication
(10) Pub. No.: US 2012/0147257 A1
(43) Pub. Date: Jun. 14, 2012

(54) ELECTRONIC APPARATUS INCORPORATING RECORDING MEDIUM FOR RECORDING DATA SUCH AS IMAGE AND/OR CHARACTER

(75) Inventor: Seiichi KATO, Yamato-shi (JP)

(73) Assignee: CANON KABUSHIKI KAISHA, Tokyo (JP)

(21) Appl. No.: 13/313,095

(22) Filed: Dec. 7, 2011

(30) Foreign Application Priority Data
Dec. 10, 2010 (JP) 2010-275771
Nov. 8, 2011 (JP) 2011-244565

(51) Int. Cl. H04N 5/225

(52) U.S. Cl. 348/374; 348/E05.024

(57) ABSTRACT

An electronic apparatus having a mechanism configured to, when disposing of the electronic apparatus, reliably prevent data from being leaked out from a recording medium incorporated in the electronic apparatus with simple work not requiring taking the electronic apparatus apart. A recording board is provided inside an apparatus body. A recording medium is mounted on the recording board. A terminal board is provided inside the apparatus body. A connection terminal is mounted on the terminal board. A terminal hole of the connection terminal connects with an external apparatus and opens externally of the apparatus body. The terminal hole extends through the connection terminal, and a surface of the recording board is disposed so as to intersect with an extension of an axis of the terminal hole.

### BACKGROUND OF THE INVENTION

1. Field of the Invention

The present invention relates to an electronic apparatus such as, for example, a digital camera, and more specifically, to an electronic apparatus incorporating a recording medium for recording data such as an image or a character.

2. Description of the Related Art

Conventionally, a device configured to, when disposing of a rotating disk such as a CD or a DVD, scratch the entire recording surface of the rotating disk to disable reading of data from the rotating disk has been proposed (Japanese Laid-Open Patent Publication (Kokai) No. 2004-288318).

However, the device disclosed in Japanese Laid-Open Patent Publication (Kokai) No. 2004-288318 is not available to a recording medium incorporated in an electronic apparatus such as a digital camera. Private data of, e.g., images and/or characters is recorded in a data recording medium incorporated in an electronic apparatus such as a digital camera as well, and thus, it is desirable to prevent data from a recording medium incorporated in, e.g., a digital camera from being leaked out when disposing of the digital camera.

### SUMMARY OF THE INVENTION

Therefore, the present invention provides an electronic apparatus having a mechanism configured to, when disposing of the electronic apparatus, reliably prevent data from being leaked out from a recording medium incorporated in the electronic apparatus with simple work not requiring taking the electronic apparatus apart.

In a first aspect of the present invention, there is provided an electronic apparatus comprising an apparatus body, a recording board provided inside the apparatus body, the recording board including a recording medium mounted thereon, and a terminal board provided inside the apparatus body, the terminal board including a connection terminal mounted thereon, the connection terminal including a terminal hole configured to connect with an external apparatus, the terminal hole opening externally of the apparatus body, wherein the terminal hole extends through the connection terminal, and a surface of the recording board is disposed so as to intersect with an extension of an axis of the terminal hole.

According to the present invention, it is possible to, when disposing of an electronic apparatus, reliably prevent data from being leaked out from a recording medium incorporated in the electronic apparatus with simple work not requiring taking the electronic apparatus apart.

The above and other objects, features, and advantages of the invention will become more apparent from the following detailed description taken in conjunction with the accompanying drawings.

### BRIEF DESCRIPTION OF THE DRAWINGS

FIG. 1 is a perspective view of an outer appearance of a digital video camera, which is an electronic apparatus according to a first embodiment of the present invention, viewed from the front side.

FIG. 2 is a perspective view of the digital video camera shown in FIG. 1 with a display unit opened, viewed from the back side.

FIG. 3 is a perspective view schematically showing an inner structure of a camera body of the digital video camera shown in FIG. 1.

FIG. 4 is a perspective view of a connection terminal and a terminal board in the camera body.

FIG. 5 is a perspective view of a terminal holder holding the connection terminal.

FIG. 6 is a perspective view showing a state in which the terminal holder is attached to the terminal board.

FIG. 7 is a perspective view showing a state in which a shaft of a screw driver is inserted into a terminal hole of the connection terminal when disposing of the digital video camera.

FIG. 8 is a cross-sectional view along an extension of an axis of the terminal hole of the camera body in the state in FIG. 7.

FIG. 9 is a perspective view schematically showing an inner structure of a camera body of a digital video camera which is an electronic apparatus according to a second embodiment of the present invention.

FIG. 10 is a perspective view according to the second embodiment showing a state in which a terminal holder is attached to a terminal board.

### DESCRIPTION OF THE EMBODIMENTS

The present invention will now be described in detail with reference to the drawings showing preferred embodiments thereof. It should be noted that the relative arrangement of the components, the numerical expressions and numerical values set forth in these embodiments do not limit the scope of the present invention unless it is specifically stated otherwise.

### First Embodiment

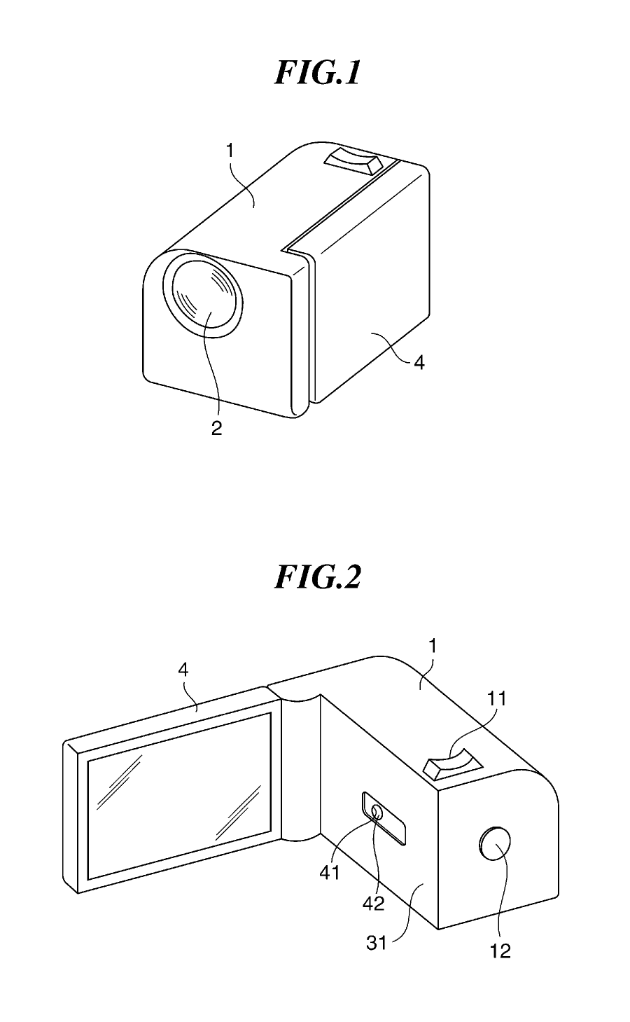

FIG. 1 is a perspective view of an outer appearance of a digital video camera, which is an electronic apparatus according to a first embodiment of the present invention, viewed from the front side, and FIG. 2 is a perspective view of the digital video camera shown in FIG. 1 with a display unit opened, viewed from the back side.

As shown in FIGS. 1 and 2, the digital video camera according to the first embodiment includes a lens unit 2 arranged on the front side of the camera body 1, a zoom lever 11 arranged on the upper side, and a trigger switch 12 arranged on the back side for operation to start/stop shooting.

Furthermore, a display unit 4 is openably/closably supported at a side on the right side of the camera body 1, viewed from the front side of the camera body 1. The display unit 4 is held in a recess section 31 of the camera body 1 when the display unit 4 is closed, and the recess section 31 includes a terminal hole 42 of a connection terminal 41 for connecting with an external apparatus such as a microphone or a television, the terminal hole 42 opening externally. Here, the camera body 1 corresponds to an example of an apparatus body of the present invention.

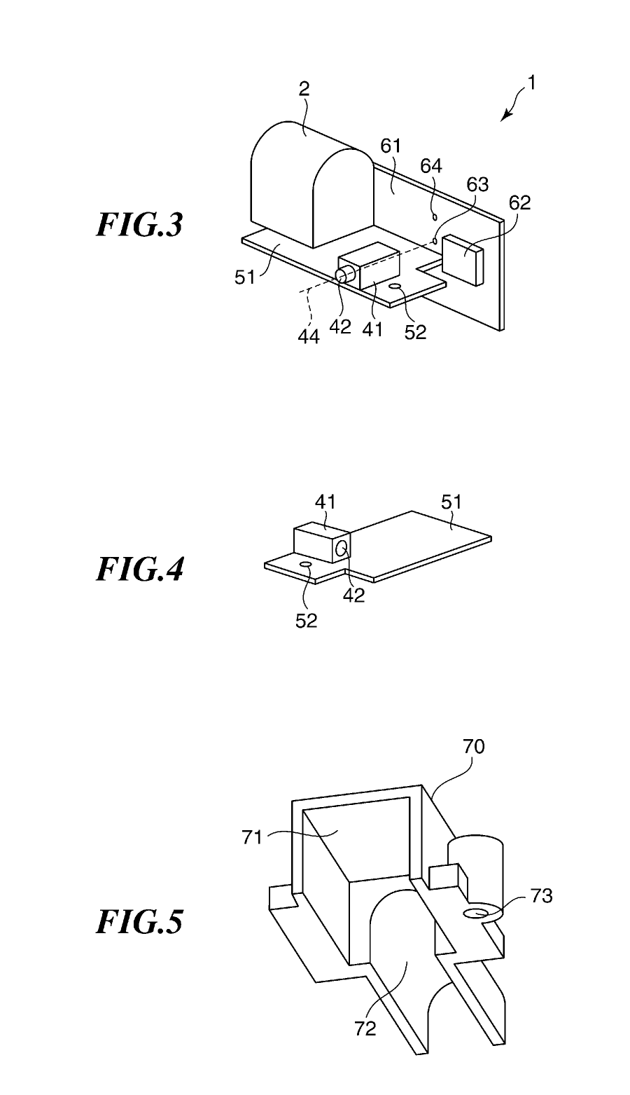

FIG. 3 is a perspective view schematically showing an inner structure of the camera body 1 of the digital video camera shown in FIG. 1, and FIG. 4 is a perspective view of the connection terminal 41 and a terminal board 51 in the camera body 1.

As shown in FIG. 3, the terminal board 51 is horizontally provided on the lower side of the lens unit 2, and the connection terminal 41 is mounted on an upper surface of the terminal board 51. At a side of the camera body 1 perpendicular to the direction of an axis of the lens unit 2, a recording board 61 is provided substantially orthogonal to the terminal board 51, and a recording medium 62 such as a semiconductor memory is mounted on a surface of the recording board 61 that faces the connection terminal 41.

Furthermore, as shown in FIGS. 3 and 4, the terminal hole 42 of the connection terminal 41 extends through the inside of the connection terminal 41 toward the recording board 61. The recording board 61 is disposed so that a surface thereof intersects with an extension of an axis 44 of the terminal hole 42. The surface of the recording board 61 includes a hole 63 having, for example, a circular shape which has a diameter smaller than a diameter of the terminal hole 42 on the extension of the axis 44 of the terminal hole 42. The surface of the recording board 61 on the connection terminal 41 side includes another hole 64 having, for example, a circular shape, in the vicinity of the hole 63. The terminal board 51 also includes a hole 52 provided on an extension of an axis of a hole in a boss section 73 which will be described later.

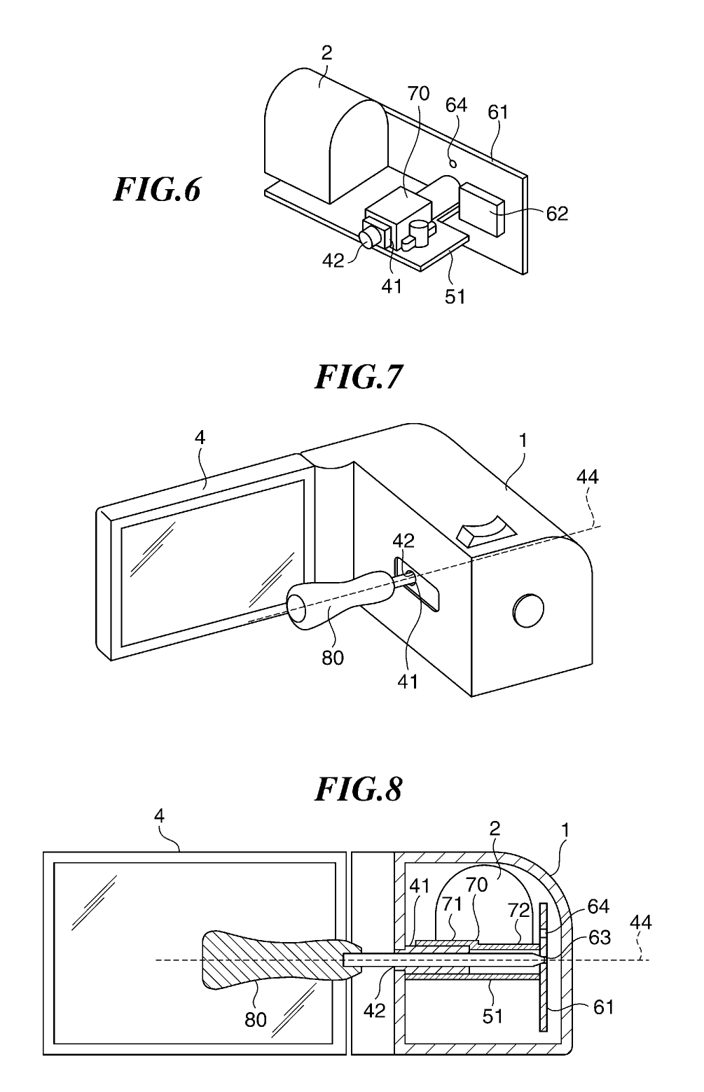

FIG. 5 is a perspective view of a terminal holder 70 holding the connection terminal 41, and FIG. 6 is a perspective view showing a state in which the terminal holder 70 is attached to the terminal board 51.

As shown in FIG. 5, the terminal holder 70, which is formed by, e.g., an insulating material, includes a cover section 71 having a squared U-shape in cross section, a cover section 72 adjacent to the cover section 71 having a U-shape in cross section, and the boss section 73 for screw fastening, which is provided on a side of the cover section 71.

As shown in FIG. 6, a screw, not shown, is inserted into a hole in the boss section 73 in a state in which the connection terminal 41 is covered by the cover section 71 of the terminal holder 70 and fastened in the hole 52 of the terminal board 51 (see FIGS. 3 and 4) with a tip of the screw engaged with the hole 52, whereby the terminal holder 70 is fixed to the terminal board 51. In such fixed state, the cover section 72 of the terminal holder 70 covers a space between the surface of the recording board 61 and an opening of the terminal hole 42 on the surface side of the recording board 61, jointly with the surface of the terminal board 51.

FIG. 7 is a perspective view showing a state in which a shaft of a screw driver 80 is inserted into the terminal hole 42 of the connection terminal 41 when disposing of the digital video camera. FIG. 8 is a cross-sectional view along the extension of the axis 44 of the terminal hole 42 of the camera body 1 in the state in FIG. 7.

As shown in FIG. 8, the shaft of the screw driver 80 inserted into the terminal hole 42 of the connection terminal 41 penetrates through the terminal hole 42 and the cover section 72 of the terminal holder 70, and a tip of the screw driver 80 engages with the hole 63 formed in the recording board 61. Here, the screw driver 80 is a driver for a cross slot screw. It should be noted that any article other than the screw driver 80 may be used as long as the article has a stick-like shape that can penetrate through the terminal hole 42.

Then, pushing the screw driver 80 in this state more firmly enables to destroy the recording board 61, thus disabling to read data from the recording medium 62.

Here, an inclined surface of the tip of the shaft of the screw driver 80 engages with the hole 63 formed in the recording board 61, whereby a force can be conveyed to the recording board 61 without slippage of the tip of the shaft. Furthermore, the hole 64 formed in the vicinity of the hole 63 further facilitates easy destruction of the recording board 61.

Furthermore, a section of the shaft of the screw driver 80 that projects from the terminal hole 42 toward the recording board 61 is covered by the cover section 72 of the terminal holder 70 and the terminal board 51, which eliminates the possibility of the section coming into contact with wire members inside the camera body 1 and/or other high-voltage circuits, thus enabling safe destruction of the recording board 61.

As described above, in the first embodiment, it is possible to, when disposing of the digital video camera, reliably prevent data from being leaked out from the recording medium 62 incorporated in the digital video camera with simple work not requiring taking the digital video camera apart.

It should be noted that the components of the present invention are not limited to those described in the above embodiment, and can arbitrarily be altered in terms of, e.g., material, shape, dimensions, mode, the numbers and/or arrangement position, without departing from the scope of the present invention.

For example, while the above first embodiment has been described a case where two circular holes 63 and 64 are formed in the recording board 61, but holes like those in a line of perforation or a slit-like hole may be formed in the recording board 61 instead of the circular holes 63 and 64. Furthermore, while in the above first embodiment, the holes 63 and 64 are provided in the recording board 61, and the hole 52 is provided in the terminal board 51, these holes may be omitted. Furthermore, if the wire members and the other high-voltage circuits inside the camera body 1 are not arranged in the vicinity of the extension of the axis 44 of the terminal hole 42, the connection terminal 41 may not be covered by the terminal holder 70.

### Second Embodiment

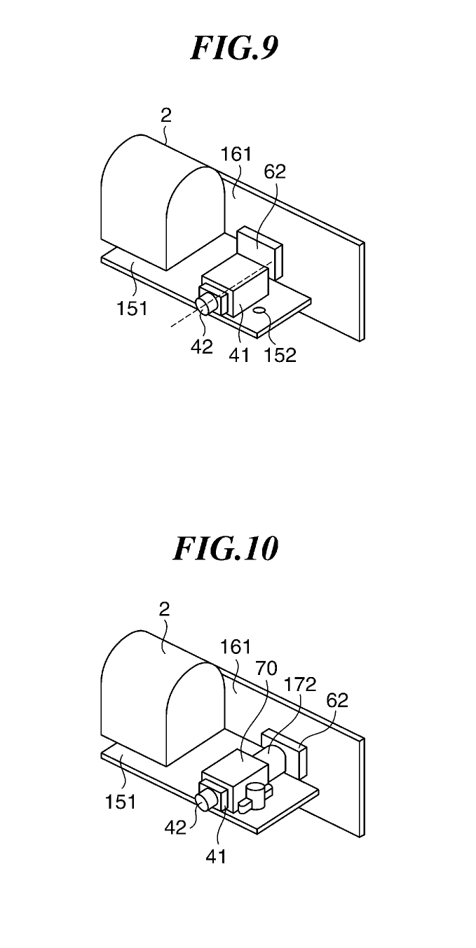

Hereinafter, an electronic apparatus according to a second embodiment of the present invention will be described using FIGS. 9 and 10. Like parts common to those of the first embodiment are denoted by like numerals, and a duplicated description thereof will be omitted.

As shown in FIG. 9, a terminal board 151 is horizontally provided on the lower side of the lens unit 2, and the connection terminal 41 is mounted on an upper surface of the terminal board 151. Similarly to the first embodiment, a surface of a recording board 161 is substantially orthogonal to the extension of the axis 44 of the terminal hole 42 of the connection terminal 41. In the second embodiment, as shown in FIG. 9, the recording medium 62 such as a semiconductor memory is mounted on a surface of the recording board 161, so that the recording medium 62 extends through the axis 44 of the terminal hole 42 of the connection terminal 41.

FIG. 10 is a perspective view showing a state in which the terminal holder 70 is attached to the terminal board 51 which includes, e.g., an insulating material. The terminal holder 70 is same as shown in FIG. 5 but the cover section 172 having a squared U-shape in cross section is length shorter than the cover section 72 shown in FIG. 3 by the thickness of the recording medium 62.

As shown in FIG. 10, a screw, not shown, is inserted into a hole in the boss section 73 in a state in which the connection terminal 41 is covered by the cover section 71 of the terminal holder 70 and fastened in the hole 152 of the terminal board 151 (see FIG. 9) with a tip of the screw engaged with the hole 152, whereby the terminal holder 70 is fixed to the terminal board 151. In such fixed state, the cover section 72 of the terminal holder 70 covers a space between the surface of the recording board 61 and an opening of the terminal hole 42 on the surface side of the recording board 61, jointly with the surface of the terminal board 151.

As is the case with the first embodiment shown in FIG. 7, when the shaft of the screw driver 80 (not shown) is inserted into the terminal hole 42 of the connection terminal 41 shown in FIG. 10, the shaft of the screw driver 80 penetrates through the terminal hole 42 and the cover section 172 of the terminal holder 70, and a tip of the screw driver 80 reaches the surface of the recording medium 62. Then, pushing the screw driver 80 in this state more firmly enables to destroy the recording medium 62 reliably. The recording medium 62 is destroyed physically, which disables to read data from the recording medium 62.

Furthermore, a section of the shaft of the screw driver 80 that projects from the terminal hole 42 toward the recording medium 62 is covered by the cover section 172 of the terminal holder 70 and the terminal board 151, which eliminates the possibility of the section coming into contact with wire members inside the camera body 1 and/or other high-voltage circuits, thus enabling safe destruction of the recording medium 62.

As described above, in the second embodiments, it is possible to, when disposing of the digital video camera, reliably prevent data from being leaked out from the recording medium 62.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2010-275771, filed Dec. 10, 2010, and No. 2011-244565, filed Nov. 8, 2011, which are hereby incorporated by reference herein in their entirety.

What is claimed is:

1. An electronic apparatus comprising:
an apparatus body;
a recording board provided inside said apparatus body, said recording board including a recording medium mounted thereon; and
a terminal board provided inside said apparatus body, said terminal board including a connection terminal mounted thereon, the connection terminal including a terminal hole configured to connect with an external apparatus, the terminal hole opening externally of said apparatus body,
wherein the terminal hole extends through the connection terminal, and a surface of said recording board is disposed so as to intersect with an extension of an axis of the terminal hole.

2. The electronic apparatus according to claim 1, wherein a hole having a diameter smaller than a diameter of the terminal hole is formed on the extension of the axis of the terminal hole at the surface of said recording board.

3. The electronic apparatus according to claim 1, further comprising a cover section configured to cover a space between the surface of said recording board and an opening of the terminal hole on the surface side of said recording board, jointly with a surface of said terminal board.

4. The electronic apparatus according to claim 3, further comprising a terminal holder fixed to said terminal board with the connection terminal covered,
wherein said cover section is included in said terminal holder.

5. An electronic apparatus comprising:
an apparatus body;
a recording board provided inside said apparatus body, said recording board including a recording medium mounted thereon; and
a terminal board provided inside said apparatus body, said terminal board including a connection terminal mounted thereon, the connection terminal including a terminal hole configured to connect with an external apparatus, the terminal hole opening externally of said apparatus body,
wherein the terminal hole extends through the connection terminal, and the recording medium mounted on said recording board is disposed so as to intersect with an extension of an axis of the terminal hole.
